(19) United States
(12) Patent Application Publication
(10) Pub. No.: US 2025/0319996 A1
(43) Pub. Date: Oct. 16, 2025

(54) Pressure Suit

(71) Applicant: Jaywant Philip Parmar, Lacey, WA (US)

(72) Inventor: Jaywant Philip Parmar, Lacey, WA (US)

(21) Appl. No.: 18/063,645

(22) Filed: Dec. 8, 2022

Related U.S. Application Data
(60) Provisional application No. 63/287,073, filed on Dec. 8, 2021.

(51) Int. Cl. B64G 6/00; A61H 9/00; B64G 1/40

(52) U.S. Cl. CPC B64G 6/00; A61H 9/005; A61H 2201/107; A61H 2201/165; A61H 2201/5007; A61H 2209/00; A61H 2230/625; B64G 1/40

(57) ABSTRACT

A pressure suit includes a communication unit, pressure actuators, and a control unit. The communication unit is configured to receive first data relating to the user's posture. The pressure actuators are located at different locations of the pressure suit and correspond to respective body parts, and are configured to selectively apply variable pressures on the respective body parts of the user when the pressure suit is worn by the user. The control unit configured to process the first data in or near real time and to selectively operate the pressure actuators in or near real time, so as to apply a desired pressure profile on the body of the user according to the posture of the user indicated by the first data, in order to create a venous blood pool that is similar to a venous blood pool that the user would have on Earth for the same posture.

### CROSS-REFERENCES TO RELATED APPLICATIONS

This application claims priority from U.S. Provisional Application Ser. No. 63/287,073 filed Dec. 8, 2021, which is hereby incorporated herein by reference in the respective in its entirety.

### TECHNICAL FIELD

This present invention, in some embodiments thereof, relates a pressure suit for use in microgravity.

### BACKGROUND OF THE INVENTION

Human bodies are adapted to live under Earth gravity, and many of the human body's physiological mechanism are based on the presence of gravity or a gravity-like force.

One of these physiological mechanisms relates to venous blood pool shifts associated with postural changes. Flow characteristics of blood throughout the body changes depending on a person's posture and activity. For example, when a person stands, more blood is located in the lower locations of the body (legs, feet, for example) than at the chest, and heart beat elevates to counter gravity and distribute blood throughout the circulatory system. When a person is supine, blood is distributed more evenly on the body, and consequently less force is necessary for blood distribution and heart rate decreases (compare to the heart rate in a standing posture).

Changes in the blood flow characteristics affect other activities of the body. For example, the conditions necessary for sleep are more easily reached in a supine posture, while the conditions necessary for the body to perform more energetic work is achieved in a standing posture.

In microgravity, the blood flow is not affected by gravity and remains the same at all orientations. This makes it harder for the body to better fit certain activities (e.g., work, sleep) based solely on the body's posture.

System for simulating gravity in space have been devised in order enhance people's comfort in microgravity conditions and to decrease negative effects on a person's health in microgravity.

One of these gravity-simulating systems is a rotational spaceframe which simulates gravity by creating rotation of a portion of the spaceframe about a central axis. The centrifugal force felt by users on the rotation portions simulate gravity. However, such rotational spaceframes are bulky and expensive.

### Brief Summary of Embodiments of the Invention

The present invention seeks to replace the rotational spaceframes (mechanical centrifuges) required for creation of artificial (Earth) gravity in Space with a more compact, cost effective and rapidly-scalable life support system. The system of the present invention includes a suit that determines how to recreate the earthbound physiological condition for that body's venous blood pool, in space. In the physiological sense, this is similar to creating artificial gravity for venous blood pooling.

The suit is also programmed to change between pressure profiles when posture is changed, to match venous blood pooling changes that occur on Earth for the same posture change.

Therefore, an aspect of some embodiments of the present invention relates to a system for creating, for at least one user in a spacecraft in microgravity, a desired venous pool. The system includes posture recognition module and at least one pressure suit. The one or more cameras is disposed in the spacecraft. The posture recognition module is configured to identify at least one posture of the at least one user in the spacecraft and to generate, in real time or near-real time, first data indicative of the identified postures of the at least one user. Each pressure suit configured is for being worn by a respective one user, and includes a communication unit, a plurality of pressure actuators, a control unit. The communication unit is configured to receive the first data relating to the at least one user from the posture recognition module. The pressure actuators are located at different locations of the suit and corresponding to respective body parts, each pressure actuator being configured to selectively apply variable pressure on the respective body part of the user when the pressure suit is worn by the user. The control unit is configured to process the first data in real time or near real time and to selectively operate the pressure actuators in real time or near real time, so as to apply a desired pressure profile on the body of the user according to the at least one posture of the user determined by the posture recognition module, in order to create a venous blood pool that is similar to a specific venous blood pool that the user would have on Earth for a same posture.

In a variant, the posture recognition module is configured to identify at least two postures. The control unit is configured to process the first data in real time or near real time and to selectively operate the pressure actuators in real time or near real time, so as to apply a respective desired pressure profile on the body of the user according to an identified posture from the at least two postures of the user, in order to create a venous blood pool that is similar to a specific venous blood pool that the user would have on Earth for a same posture. The control unit is configured to process the first data in real time or near real time and to selectively operate the pressure actuators in real time or near real time, so as to apply a desired pressure profile changes on the body of the user when a change between the at least two postures occurs, in order to create a venous blood pool change that is similar to a specific venous blood pool change that the user would experience on Earth for the same posture change.

In another variant, wherein the suit comprises footies, pants, a shirt, and gloves. The footies are configured to be worn over feet of the user. The pants are configured to be worn on the body of the user from bottoms of legs to a pelvis of the user. The shirt is configured to be worn on the body of the user from the pelvis, over an abdomen and a chest, up to and including a neck of the user, the shirt having sleeves covering arms of the user, from shoulders to wrists. The gloves, configured to be worn over hands of the user.

In yet another variant, the suit further comprises variably pressurized goggles or helmet configured to be worn by the at least one user and cover eyes of the at least one user, wherein the control unit is configured to regulate air pressure within the goggles or helmet according to the identified posture.

In a further variant, the suit further comprises variably pressurized ear pieces configured to be worn by the user and apply variable pressure on the user's ear, wherein the control unit is configured to regulate air pressure of the ear pieces according to the identified posture.

In yet a further variant, the suit further comprises a respirator mask configured to be worn by the user to cover a mouth and nose of the user, the respirator mask being configured to provide variably pressurized air to the mouth and nose of the user, wherein the control unit is configured to regulate air pressure provided by the respirator mask according to the identified posture.

In a variant, the system further comprising an air pressure sensor configured to measure air pressure within the spacecraft cabin and generate cabin air pressure data. The control unit is configured to process the first data and the air pressure data in real time or near real time and to selectively operate the pressure actuators in real time or near real time, so as to apply the desired pressure profile relative to the air pressure within the spacecraft cabin.

In some embodiments of the present invention, the system includes a monitoring apparatus configured to monitor at least one parameter of the user's body and to generate second data indicative of the at least one parameter of the user's body. Wherein the control unit is configured to process the first data and the second data and to control the pressure actuators to apply the desired pressure profile on the body of the user according to the identified posture of the user, while maintaining the at least one parameter within a predetermined desired range corresponding to the identified posture.

In a variant, the monitoring apparatus comprises an electrocardiogram monitor and the parameter comprises electrical activity of the heart. The control unit is configured to process the first data and the second data to control the pressure actuators to apply the desired pressure profile on the body of the user according to the identified posture of the user, while maintaining the electrical activity of the heart within the predetermined desired range corresponding to the identified posture.

In another variant, the monitoring apparatus comprises an ultrasound monitor and the parameter comprises venous diameters of at least one of bilateral femoral veins, bilateral axillary/brachial veins, and bilateral internal jugular veins. Wherein the control unit is configured to process the first data and the second data to control the pressure actuators to apply the desired pressure profile on the body of the user according to the identified posture of the user, while maintaining the venous diameters within the predetermined desired ranges corresponding to the identified posture.

In yet another variant, the system further comprising variably pressurized goggles configured to be worn by the at least one user and cover eyes of the at least one user. The monitoring apparatus comprises an ocular proptosis detector, and the parameter comprises ocular proptosis. Wherein the control unit is configured is configured to process then first data and the second data, to control the pressure actuators to apply the desired pressure profile on the body of the user according to the identified posture of the user and to regulate air pressure within the goggles according to the identified posture in order to maintain the ocular proptosis within the predetermined desired range corresponding to the identified posture.

In a further variant, the system further comprises a respirator mask or helmet configured to be worn by the user to cover a mouth and nose of the user, the respirator mask being configured to provide variably pressurized air to the mouth and nose of the user. The monitoring apparatus comprises a respiratory circuit pressure sensor and the parameter comprises respiratory circuit pressure. The control unit is configured is configured to process then first data and the second data, to control the pressure actuators to apply the desired pressure profile on the body of the user according to the identified posture of the user and to regulate the respirator mask or helmet according to the identified posture and to maintain the respiratory circuit pressure within the predetermined desired range corresponding to the identified posture.

In yet a further variant, the monitoring apparatus comprises a central venous catheter, and the parameter comprises central venous pressure. The control unit is configured is configured to process the first data and the second data, to control the pressure actuators to apply the desired pressure profile on the body of the user according to the identified posture of the user and to regulate the pressure actuators according to the identified posture and to maintain the central venous pressure within the predetermined desired range corresponding to the identified posture.

In a variant, the posture recognition module comprises one or more cameras disposed in the spacecraft, and an image processing apparatus, configured to receive images from the cameras and identifying the at least one posture of the at least one user in the spacecraft and to generate, in real time or near-real time, the first data indicative of the identified postures of the at least one user.

Another aspect of some embodiments of the present invention relates to a pressure suit configured for being worn by a user. The pressure suit includes a communication unit, a plurality of pressure actuators, and a control unit. The communication unit is configured to receive the first data relating to a posture of the user. The pressure actuators are located at different locations of the pressure suit and corresponding to respective body parts, each pressure actuator being configured to selectively apply variable pressure on the respective body part of the user when the pressure suit is worn by the user. The control unit is configured to process the first data in real time or near real time and to selectively operate the pressure actuators in real time or near real time, so as to apply a desired pressure profile on the body of the user according to the posture of the user indicated by the first data, in order to create a venous blood pool that is similar to a specific venous blood pool that the user would have on Earth for the a same posture.

In a variant, the control unit is configured to process the first data in real time or near real time and to selectively operate the pressure actuators in real time or near real time, so as to apply a desired pressure profile changes on the body of the user when the communication unit receives the first data that is indicative of a change between two postures, in order to create a venous blood pool change that is similar to a specific venous blood pool change that the user would experience on Earth for the same posture change.

Another aspect of some embodiments of the present invention relates to a method for calibrating a pressure suit, for at least one user in a spacecraft in microgravity, a desired venous pool, the method comprising: measuring, on Earth, one or more circulatory system parameter while switching a subject with a predetermined body habitus between different postures and recording measurements as calibration data; in microgravity, providing the pressure suit so that the pressure suit is worn by the subject, the pressure suit comprising: a communication unit, configured to process the first data in real time or near real time and to selectively operate the pressure actuators in real time or near real time, so as to apply a desired pressure profile on the body of the user according to the posture of the user indicted by the first data, in order to create a venous blood pool that is similar to a specific venous blood pool that the user would have on Earth a same identified posture; activating the actuators of the pressure suit to generate pressure profiles, while one or more circulatory system parameters corresponding to the calibration data are measured; adjusting the pressure profiles so that the circulatory system parameters measured in microgravity match to the circulatory system parameters of the calibration data; once a match is found, determining a pressure profile for a respective posture is and programming the pressure suit to apply a pressure profile for the respective postures when the pressure suit receives the first data indicative of the respective postures, so as to provide, for each posture venous blood pooling that would occur for a same posture on Earth.

In a variant, the control unit is configured to process the first data in real time or near real time and to selectively operate the pressure actuators in real time or near real time, so as to apply a desired pressure profile changes on the body of the user when the communication unit receives the first data that is indicative of a change between two postures, in order to create a venous blood pool change that is similar to a specific venous blood pool change that the user would experience on Earth for a same posture change.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a block diagram of a system for creating a desired venous pool, for at least one user in a spacecraft in microgravity, according to some embodiments of the present invention; and

FIG. 2 illustrates a suit for creating a desired venous pool, for a user in a spacecraft in microgravity, according to some embodiments of the present invention; and

FIG. 3 is a flowchart of a method for calibrating a pressure suit for generating a desired venous blood pool in microgravity, according to some embodiments of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

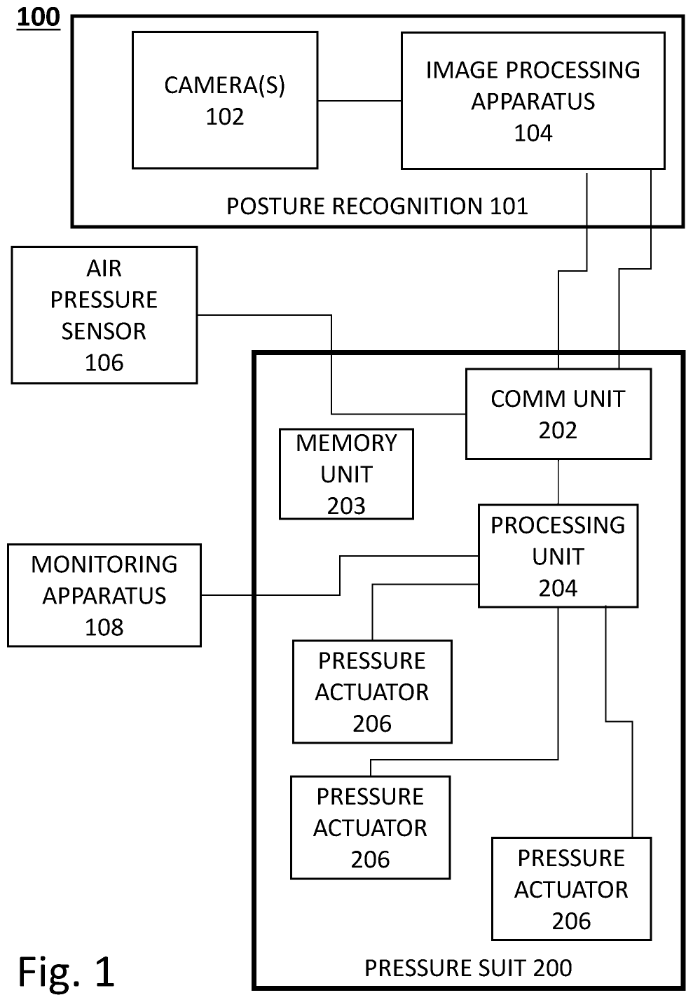

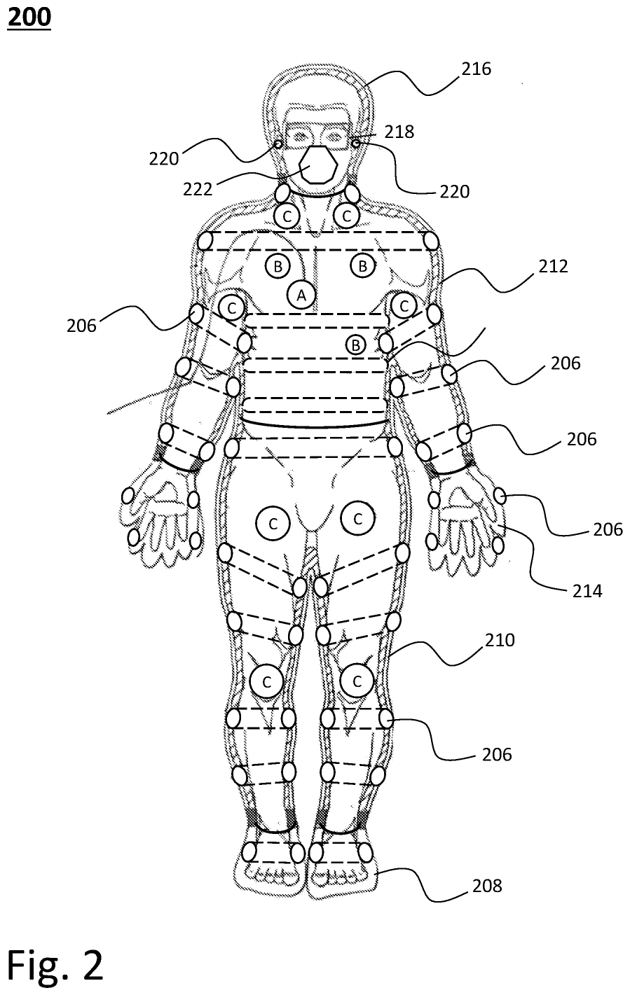

FIG. 1 is a block diagram of a system 100 for creating a desired venous pool, for at least one user in a spacecraft in microgravity, according to some embodiments of the present invention. FIG. 2 illustrates a suit 200 for creating a desired venous pool, for a user in a spacecraft in microgravity, according to some embodiments of the present invention.

In FIG. 1, the system 100 incudes a posture recognition module 101 and at least one suit 200.

The posture recognition module 101 is configured to identify at least one posture of at least one user in relative to a predetermined axis in the spacecraft (or in a portion of the spacecraft) and to generate, in real time or near-real time, the first data is indicative of the identified postures of the at least one user. In some embodiments of the present invention, the posture recognition module 101 includes one or more cameras 102 and an image processing apparatus 104. The one or more cameras 100 are disposed in the spacecraft. The image processing apparatus 104 is configured to receive images from the camera(s) and identifying postures of the at least one user in the spacecraft and to generate, in real time or near-real time, first data that I indicative of the identified postures of the at least one user.

The suit 200 it configured for being worn by the user, and include a communication unit 202, a memory unit 203, a processing unit 204, and a plurality of pressure actuators 206.

The communication unit 202 is configured to receive the first data relating to the at least one user from the posture recognition module 101. The pressure actuators 206 are located at different locations of the suit 200 and correspond to respective body parts, such that each pressure actuator is located against a respective body part and configured to selectively apply variable pressure on the respective body part of the user when the suit 200 is worn by the user. Each pressure actuator may be a pneumatic actuator that can be inflated and deflated to a desired level to apply a desired pressure on the respective body part. The pneumatic actuators may completely or partially encircle the respective body parts. For example, first pressure actuators surround or partially surround the stomach and chest at different heights, second pressure actuators surround or partially surround each arm at different positions along the arms, third pressure actuators surround or partially surround each leg at different positions along the legs, fourth pressure actuators surround or partially surround each finger at one or more positions along the finger, etc.

According to some embodiments of the present invention, pneumatic actuators may be in the form of compliant fluid-filled or gas-filled balloons that encircle or are sequentially positioned within a noncompliant constraint layer. The compliant balloons are inflated or deflated between the wearer's body and the noncompliant constraint layer in order to provide variable compression to the body surface.

Optionally or additionally, the pressure actuators are in the form of a pressurized seal surrounding the area(s) to be pressure controlled. Then the isolated area that is sealed is connected to a pressurized gas source and venting system that allows for pressurization/depressurization of the sealed area. This type of pressure actuator would be used for the eyes (goggles) and lungs/airway (respirator). These two elements could be potentially combined into a helmet system that could be sealed at the neck with a neoprene collar.

The processing unit 204 is configured to process the first data in real time or near real time according to instructions stored on a non-volatile memory utility 203 in communication with the processing unit 204, and to selectively operate the pressure actuators 206 in real time or near real time, so as to apply a desired pressure profile on the body of the user according to the identified posture of the user. In this manner a venous blood pool is created in the user's body, that is similar to a specific venous blood pool that the user would have on Earth for the same identified posture.

In some embodiments of the present invention, the posture recognition module 101 is configured to identify two postures: standing and supine. For example, if the user is deemed to be standing, blood pooling in the lower part of the body needs to be higher than blood pooling in the higher part of the body, in order to simulate blood pooling on Earth (or on any other predetermined gravitational field). Thus, the pressure profile chosen by the processing unit 204 is one in which pressure applied at higher locations on the user's body is higher than pressure applied on lower locations of the body. The pressure profile is predetermined and may be generated during a calibration process on Earth prior to launch into space, that will be described further below. Information relating to the pressure profiles may be stored in the memory unit 204.

If the user is deemed to be supine, the processing unit 204 chooses a pressure profile in which pressure is substantially the same all over the body, to simulate a more even distribution of the blood that is similar to blood distribution for a supine posture on Earth.

In some embodiments of the present invention, the posture recognition module 101 is configured to identify one or more intermediates postures between standing and supine, and the memory unit 203 stores information about pressure profiles matching the one or more intermediate postures.

In some embodiments of the present invention, the posture recognition module 101 is configured to identify different positions of the limbs, such as standing with the left arm up, standing with the right arm up, supine while laying on the left side (right arm and leg higher than the left arm and leg, respectively), supine while lying on the right side (right arm and leg lower than the left arm and leg, respectively), for example.

In these examples, the pressure actuators 206 are controlled to apply a lower pressure on the lower limbs and a higher pressure on the higher limbs. In some embodiments of the present invention, a plurality of pressure actuators are positioned at different locations along the limbs. If a portion of a limb is higher than another portion of the same limb (for example, the user is standing and holding an arm up) the pressure actuators 206 on the limb apply different pressures to the different portions of the limb, so that higher portions of the limb are subjected to greater pressure than the lower portions of the limb and force some of the venous blood out of the higher portions of the higher portions of the limbs.

In the example of FIG. 2, the suit includes footies 208, pants 210, a shirt 212, and gloves 214.

The footies 208 are configured to be worn over feet of the user, and include one more pressure actuators configured to apply pressure on the user's feet. The pants 210 are configured to be worn on the body of the user, from bottoms of legs to a pelvis of the user. The pressure actuators 206 are disposed along the pants at different positions to apply pressure on the legs (at different locations) and around the pelvic area. The shirt 212 is configured to be worn on the body of the user from the pelvis, over an abdomen and a chest, up to and including a neck of the user. The shirt 212 has sleeves covering arms of the user, from shoulders to wrists. The shirt 212 incudes pressure actuators disposed at different locations to apply pressure around the abdomen, chest, arms. The gloves 214 are configured to be worn over hands of the user and include pressure actuators to apply pressure around the hands and optionally around each finger.

The suit may additionally include variably pressurized goggles 218 or a helmet 216. The goggles/helmet are configured to be worn by the user and cover eyes. The control unit is configured to regulate air pressure within the goggles or helmet according to the identified posture. For example, when the user stands pressure is higher in the googles/helmet, and when the user is supine, pressure is lower in the google helmet.

The suit may further comprise variably pressurized ear pieces 220 configured to be worn by the user and apply variable pressure on the user's ear. The control unit is configured to regulate air pressure of the ear pieces according to the identified posture. Earpieces may balance airway pressures, and affect the central venous blood pool, since airway pressure contacts the central venous blood pool through pulmonary circulation.

The suit 200 may further comprise a respirator mask 222 configured to be worn by the user to cover a mouth and nose of the user. The respirator mask is configured to provide variably pressurized air to the mouth and nose of the user, and the control unit is configured to regulate air pressure provided by the respirator mask according to the identified posture. This respired air pressure is in direct contact with the central venous blood pool and may be used to induce changes in the central venous pressure.

Going back to FIG. 1, in some embodiments of the present invention, the system 100 further includes an air pressure sensor 106 configured to measure air pressure within the spacecraft cabin and generate cabin air pressure data. The air pressure sensor 106 is in communication with the processing unit 204 of the suit 200 via the communication unit 202. The processing unit 204 is configured to process the first data and the air pressure data in real time or near real time and to selectively operate the pressure actuators 206 in real time or near real time, so as to apply the desired pressure profile relative to the air pressure within the spacecraft cabin.

In some embodiments of the present invention, the system 100 includes a monitoring apparatus 108 configured to monitor at least one parameter of the user's body and to generate second data indicative of the at least one parameter of the user's body. The monitoring apparatus is in the communication with the processing unit 204 either directly or via the communication unit 202, and is configured to transmit the second data to the processing unit 204. The monitoring apparatus may be part of the suit 200 or separate from the suit 200. The control unit 204 is configured to process the first data from the posture recognition module 101 and the second data from the monitoring apparatus 108, and to control the pressure actuators 206 to apply a desired pressure profile on the body of the user according to the identified posture of the user, while maintaining the at least one parameter within a predetermined desired range corresponding to the identified posture.

Referring now to FIG. 2 again, in some embodiments of the present invention, the monitoring apparatus 108 includes an electrocardiogram monitor B and the monitored parameter includes electrical activity of the heart. The control unit 204 is configured to process the first data and the second data and to control the pressure actuators to apply the desired pressure profile on the body of the user according to the identified posture of the user, while maintaining the electrical activity of the heart within the predetermined desired range corresponding to the identified posture.

To understand how applying a desired pressure profile on the body affects the heart's activity, it should be noted that

$$C O = SV \times HR$$

where CO is Cardiac Output, SV is Stroke Volume, while HR is Heart Rate.

The control of the heart rate is secondary via induction of autonomic reflexes related to baroreceptors (stretch receptors) mainly within the large venous conduits in the body. When a person rises from a supine posture to standing, there is a reflexive increase in sympathetic tone to the cardiac pacemakers in order to compensate for the decreased SV associated with decreased right atrial “filling” pressures as blood falls into the lower body and the right atrium is elevated relative to the legs. The stretching of the veins of the lower body elicits an increase in sympathetic tone, thereby transiently and reflexively increasing the heart rate. The suit therefore operates in the subtle regimes, eliciting venous fluid shifts on timescales that exercise the autonomic circuits related to gravitation that would be absent in microgravity. In other words, the suit causes different blood pooling.

This is explained in the article “Understanding basic vein physiology and venous blood pressure through simple physical assessments”, authored by Etain A. Tansey, Laura E. A. Montgomery, Joe G. Quinn, Sean M. Roe, and Christopher D. Johnson in Advances in Physiology Education, Vol. 43, No. 3, published on Aug. 13, 2019:

“Postural changes represent a major physiological challenge to blood pressure, and normal physiological adjustments need to occur to preserve blood flow to critical organs. When standing from a supine posture, gravitational forces “pull” venous blood to the lower limbs (this also occurs on the arterial side). Due to the high compliance of veins, ˜500 ml of blood can be redistributed to peripheral veins; this is known as venous pooling, which does not refer to a stagnant pool of blood, rather it refers to the slower transit time of blood through the venous circulation. This venous pooling leads to an immediate drop in stroke volume of 40% and an overall drop in cardiac output of 20%. However, mean arterial blood pressure is normally preserved, as there are compensatory increases in vascular tone mediated by the autonomic nervous system. Nevertheless, even healthy humans sometimes experience lightheadedness due to a transient drop in arterial pressure that occurs in the initial few seconds of standing”.

Therefore, the Heart Rate measured by the electrocardiogram monitor B is used by the processing unit to as feedback to check whether the pressure profile applied to the user's body is correct. For example, during calibration on Earth, the user's heart rate is measured in the postures that can be detected by the posture recognition module 101 and a desired range for each posture is determined. Additionally, the properties (e.g. time scale) of the hear rate change during at least one postural change on Earth may also be measured If the user's heart rate on Earth is within a certain range when the user is the standing posture, the correct pressure profile applied to the user's body in microgravity will also give rise to a heart rate within the same range, when the user is deemed to be standing. Optionally, the same applies to all other postures, and, importantly, changes between the postures. Indeed, it is during changes between supine versus standing and vice-versa that the homeostatic autonomic reflexes are fully activated. If, for certain postural change, the heart rate change is outside the Earth observed change in microgravity (e.g., occurs over a period of time that does not correspond to the time scale in which such a change occurs on Earth), chances are the pressure profile does not correctly simulate gravity for that posture and needs to be adjusted. In some embodiments of the present invention, adjustment instructions are stored in the memory unit 203 to be executed by the processing unit to adjust the pressure profile in order to bring the heart rate change within the Earth surface observed range for a desired postural change of the user's body.

In some embodiments of the present invention, the monitoring apparatus comprises an ultrasound monitor C and the monitored parameter comprises venous diameters of at least one of bilateral femoral veins, bilateral axillary/brachial veins, and bilateral internal jugular veins. The control unit is configured to process the first data and the second data to control the pressure actuators to apply the desired pressure profile on the body of the user according to the identified posture of the user to be simulated in microgravity, while maintaining the venous diameters within the predetermined desired ranges corresponding to the identified posture that is to be simulated.

Referring again to “Understanding basic vein physiology and venous blood pressure through simple physical assessments”, authored by Etain A. Tansey, Laura E. A. Montgomery, Joe G. Quinn, Sean M. Roe, and Christopher D. Johnson in Advances in Physiology Education, Vol. 43, No. 3, published on Aug. 13, 2019:

“There are two principal functions of veins: 1) to act as conduit vessels, transporting blood back to the heart from the body's organs and tissues (i.e., the venous return); and 2) to act as capacitance vessels, accommodating large volumes of blood. At rest, the venous structures contain approximately two-thirds of the total blood volume and thus act as a blood reservoir. The ability of veins to house this volume of blood at any given time relates to their structure. Veins have thinner walls and larger diameters than arteries with less muscle and elastic tissue. This means that they have high vascular compliance so that the rate of change in volume with changing pressure is high and, therefore, changes in venous blood volume produce relatively small changes in venous distending pressure. In fact, veins have a compliance that is 30 times that of arteries, a reason why veins can be used as arterial bypass grafts. Veins are, therefore, highly distensible, expanding easily to accommodate large volumes of blood”.

“It is known that venous capacitance vessels react to outputs from baroreceptors as well as reflexes associated with chemoreceptors and cardiac receptors. Neurohumoral mechanisms can mobilize the blood in veins to maintain filling pressure in the right heart when required. Examples of this include venoconstriction during exercise or hemorrhage where sympathetic activity via adrenergic stimulation reduces venous compliance and capacitance of the splanchnic vessels, increases peripheral venous pressure, and propels blood forward to the heart. Since venoconstriction and venodilation have significant effects on the distribution of total blood volume, both can affect CVP, stroke volume, and arterial blood pressure”.

Venous diameter is directly related to the surface pressure over the body in that region. As pressure is increased over the head and torso, proptosis decreases and venous diameters over the neck, arms, and body, and, within the pulmonary circulation will decrease. The venous blood volume (˜500 ml) will shift from upper to lower body, and, this will require geometrical changes, venous diameter changes, in the venous system.

As mentioned above, venous diameters for desired postures may be measured for a user during calibration on Earth, generating desired ranges of venous diameters corresponding to respective postures and optionally a desired property (e.g., timescale) for venous diameter changes corresponding to respective postural changes. Therefore, if one or more venous diameters diverge from the desired range in microgravity for a certain posture (and optionally if the property/properties of the changes in one or more venous diameters when postures are changed diverges from the same property/properties on Earth for the same posture change), the processor is configured to adjust the pressure profile applied by the suit (via appropriate adjustment instructions stored in the memory unit) so as to cause the diverging venous diameter(s) to enter the desired range.

In some embodiments to the present invention, the suit 200 further comprising variably pressurized goggles 218 configured to be worn by the user and cover eyes of the user. The monitoring apparatus 108 comprises an ocular proptosis detector integral with the goggles, and the monitored parameter includes ocular proptosis.

The control unit is configured is configured to process the first data and the second data, and to control the pressure actuators to apply the desired pressure profile on the body of the user according to the identified posture of the user and to regulate air pressure within the goggles according to the identified posture in order to maintain the ocular proptosis within the predetermined desired range corresponding to the identified posture.

Ocular proptosis for desired postures may be measured for a user during calibration on Earth, generating desired ranges of ocular proptosis corresponding to respective postures. Therefore, if ocular proptosis diverges from the desired range in microgravity for a certain posture, the processor is configured to adjust air pressure within the goggles (via appropriate adjustment instructions stored in the memory unit) and/or the pressure profile applied by the suit so as to cause the diverging air pressure within the goggles to enter the desired range.

In some embodiments of the present invention, the system of further comprising a respirator mask 222 or helmet 216 configured to be worn by the user to cover a mouth and nose of the user, the respirator mask 222 or helmet 216 being configured to provide variably pressurized air to the mouth and nose of the user. The monitoring apparatus comprises a respiratory circuit pressure sensor located within the respirator mask 222 or helmet 216 and near the user's mouth and nose, and the parameter includes respiratory circuit pressure. The control unit is configured to process the first data and the second data, to control the pressure actuators to apply the desired pressure profile on the body of the user according to the identified posture of the user and to regulate the air pressure in the respirator mask (or helmet) according to the identified posture, to maintain the respiratory circuit pressure within the predetermined desired range corresponding to the identified posture. Changes in the air pressure in the respirator or helmet affect the respiratory circuit pressure, which in turn affects intrathoracic pressure and central venous pressure which in turn induce venous blood pool shifts.

Respiratory circuit pressure for desired postures and optionally respiratory circuit pressure changes during postural changes may be measured for a user during calibration on Earth, generating desired ranges of respiratory circuit pressure corresponding to respective postures. Therefore, if respiratory circuit pressure diverges from the desired range in microgravity for a certain posture (and optionally if a property of the respiratory pressure changes during a postural change diverges from the same property of the respiratory pressure changes during same postural change on Earth), the processor is configured to adjust air pressure within helmet or goggles (via appropriate adjustment instructions stored in the memory unit) and/or the pressure profile applied by the suit, so as to cause the diverging air pressure within the goggles to enter the desired range. In microgravity, the respiratory circuit pressure can be utilized to change the central venous pressure and induce venous blood pool shifts that would occur due to gravitational force, thereby simulating gravity for the venous blood pool and autonomic nervous system.

In some embodiments of the present invention, wherein the monitoring apparatus comprises a central venous catheter A, and the parameter incudes central venous pressure. The control unit is configured is configured to process then first data and the second data, to control the pressure actuators and respiratory circuits (if present) to apply the desired pressure profile on the body of the user according to the identified posture of the user and to regulate the pressure actuators according to the identified posture and to maintain the central venous pressure within the predetermined desired range corresponding to the identified posture, and, during changes between these postures.

Central venous pressure for desired postures and optionally changes between these postures may be measured for a user during calibration on Earth, generating desired ranges of central venous pressure corresponding to respective postures and changes between these postures. Therefore, if central venous pressure (or optionally central venous pressure changes) diverges from the desired range in microgravity for a certain posture/postural change that is simulated, the processor is configured to adjust the pressure profile applied by the suit (via appropriate adjustment instructions stored in the memory unit), so as to cause the relative shifts in the blood pool and central and peripheral venous pressure gradients to enter the desired range.

In some embodiments of the present invention, wherein the communication unit 202 is in communication with the spacecraft propulsion system and receives third data indicative of the direction and force of generated by the propulsion system. The control unit 204 is configured to account for the third data to select the desired pressure profile to be provide by the suit, so as to simulate gravity while accounting for the spacecraft propulsion.

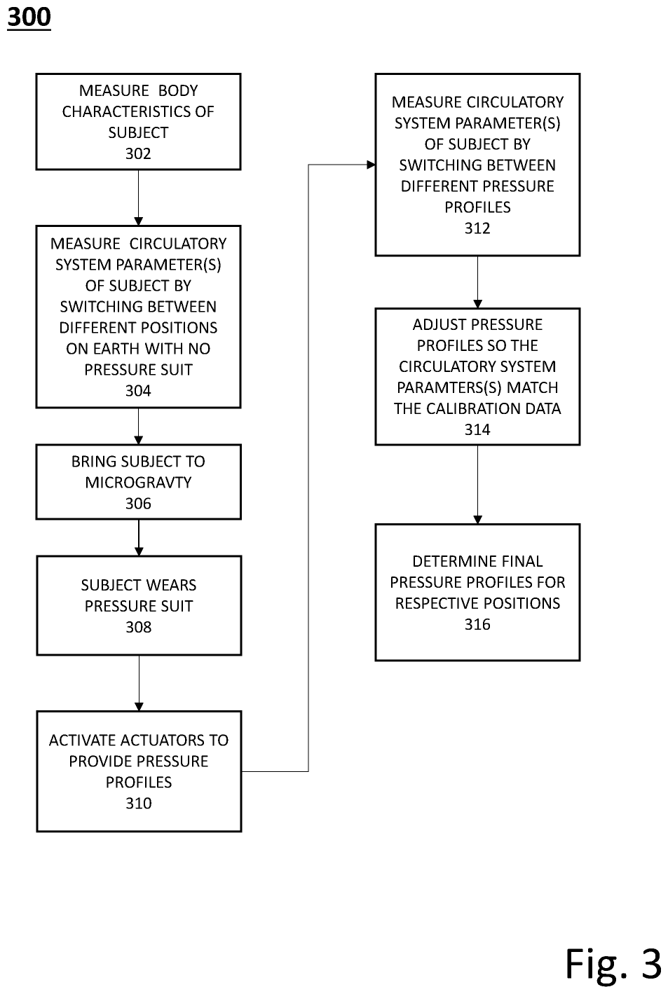

FIG. 3 is a flowchart 300 of a method for calibrating a pressure suit for generating a desired venous blood pool in microgravity, according to some embodiments of the present invention.

At 302, body characteristic of a subject having a certain body habitus are measured. The characteristics may include height and weight and a body mass index (BMI) may be calculated therefrom. Additional characteristics may include other measures of body fat, such as skinfold thicknesses, bioelectrical impedance, underwater weighing, and dual energy x-ray absorption.

At 304, circulatory system parameter(s) of subject are measured on Earth, with no pressure suit, while switching between different postures. In some embodiments of the present invention, the postures are supine and standing. The switching between the postures may be accomplished via tilt table tests, in a non-limiting example. During the switching between postures, the subject may have one or more of a central venous catheter in position, connection to an ECG monitor, and ultrasound transducers positioned over at least one of the jugular veins, axillary veins, brachial veins, femoral veins and posterior tibial veins. The measured parameters of the circulatory system may include any one or more of: the venous diameter of at least one of the jugular veins, axillary veins, brachial veins, femoral veins and posterior tibial veins; electrical activity of the heart; arterial blood pressure measurements; and central venous pressure. The measured parameters of the circulatory system would serve as the calibration data. In some embodiments of the present invention, properties of changes (such as time scale or change rate, for example) of at least one of these circulatory system parameters are also measures for one or more postural changes and also server as calibration data.

At 306, the subject is brought to microgravity. At 308 the pressure suit described above is worn by the subject.

At 310, the actuators of the pressure suit are actuated to generate pressure profiles, while one or more circulatory system parameters corresponding to those previously measured on Earth are measured (at 312). At 314, the suit is controlled, either automatically or manually, to adjust the pressure profiles so that the circulatory system parameters measured in microgravity for simulated postures correspond (within a predetermined error) to the circulatory system parameters measured on Earth (the calibration data) for the same postures. Optionally, the properties of the changes of the circulatory system parameters are also measured in microgravity, and the suit is controlled to adjust the pressure profiles so that the property or properties of the changes of the circulatory system parameters measured in microgravity during postural changes correspond (within a predetermined error) to the property or properties of the changes of the circulatory system parameters measured on Earth (calibration data). At 316, once a match is found, a pressure profile for a respective posture is determined, and the pressure suit is programmed to apply pressure profiles for respective postures when the pressure suit receives from the posture recognition module 101 data indictive of the respective postures, so as to provide, for each posture venous blood pooling that would occur for the same posture on Earth. The suit is also programmed to change between pressure profiles when posture is changed, to match venous blood pooling changes that occur on Earth for the same posture change.

In some embodiments of the present invention, after calibration and programming of the suit, the programming can be utilized for other people of the subject's body habitus (as characterized by, for example, BMI 20-22, height 5′10″ and possibly body fat composition 5% and possible other anthropomorphic parameters). In this way, other people of the subject's body habitus could use the pressure suit in microgravity to reproduce venous blood pool gravitational shifts without undergoing an individual calibration process.

What is claimed is:

1. A system for creating, for at least one user in a spacecraft in microgravity, a desired venous pool, the system comprising:
a posture recognition module configured to determine at least one posture of at least one user relative to a predetermined axis on the spacecraft;
at least one pressure suit configured for being worn by the at least one user, the suit comprising:
a communication unit, configured to receive first data relating to the at least one user from the posture recognition;
a plurality of pressure actuators located at different locations of the suit and corresponding to respective body parts, each pressure actuator being configured to selectively apply variable pressure on the respective body part of the user when the pressure suit is worn by the user;
a control unit configured to process the first data in real time or near real time and to selectively operate the pressure actuators in real time or near real time, so as to apply a desired pressure profile on the body of the user according to the at least one posture of the user determined by the posture recognition module, in order to create a venous blood pool that is similar to a specific venous blood pool that the user would have on Earth for a same posture.

2. The system of claim 1, wherein;
the posture recognition module is configured for identifying at least two postures;
the control unit is configured to process the first data in real time or near real time and to selectively operate the pressure actuators in real time or near real time, so as to apply a respective desired pressure profile on the body of the user according to an identified posture from the at least two postures of the user, in order to create a venous blood pool that is similar to a specific venous blood pool that the user would have on Earth for a same posture;
the control unit is configured to process the first data in real time or near real time and to selectively operate the pressure actuators in real time or near real time, so as to apply a desired pressure profile changes on the body of the user when a change between the at least two postures occurs, in order to create a venous blood pool change that is similar to a specific venous blood pool change that the user would experience on Earth for the same posture change.

3. The system of claim 1, wherein the suit comprises:
footies, configured to be worn over feet of the user;
pants, configured to be worn on the body of the user from bottoms of legs to a pelvis of the user;
a shirt, configured to be worn on the body of the user from the pelvis, over an abdomen and a chest, up to and including a neck of the user, the shirt having sleeves covering arms of the user, from shoulders to wrists;
gloves, configured to be worn over hands of the user.

4. The system of claim 1, wherein the suit further comprises variably pressurized goggles or helmet configured to be worn by the at least one user and cover eyes of the at least one user, wherein the control unit is configured to regulate air pressure within the goggles or helmet according to the identified posture.

5. The system of claim 1, wherein the suit further comprises variably pressurized ear pieces configured to be worn by the user and apply variable pressure on the user's ear, wherein the control unit is configured to regulate air pressure of the ear pieces according to the identified posture.

6. The system of claim 1, wherein the suit further comprises a respirator mask configured to be worn by the user to cover a mouth and nose of the user, the respirator mask being configured to provide variably pressurized air to the mouth and nose of the user, wherein the control unit is configured to regulate air pressure provided by the respirator mask according to the identified posture.

7. The system of claim 1, further comprising an air pressure sensor configured to measure air pressure within the spacecraft cabin and generate cabin air pressure data;
wherein the control unit is configured to process the first data and the air pressure data in real time or near real time and to selectively operate the pressure actuators in real time or near real time, so as to apply the desired pressure profile relative to the air pressure within the spacecraft cabin.

8. The system of claim 1, comprising a monitoring apparatus configured to monitor at least one parameter of the user's body and to generate second data indicative of the at least one parameter of the user's body;
wherein the control unit is configured to process the first data and the second data and to control the pressure actuators to apply the desired pressure profile on the body of the user according to the identified posture of the user, while maintaining the at least one parameter within a predetermined desired range corresponding to the identified posture.

9. The system of claim 8, wherein the monitoring apparatus comprises an electrocardiogram monitor and the parameter comprises electrical activity of the heart;
wherein the control unit is configured to process the first data and the second data to control the pressure actuators to apply the desired pressure profile on the body of the user according to the identified posture of the user, while maintaining the electrical activity of the heart within the predetermined desired range corresponding to the identified posture.

10. The system of claim 8, wherein the monitoring apparatus comprises an ultrasound monitor and the parameter comprises venous diameters of at least one of bilateral femoral veins, bilateral axillary/brachial veins, and bilateral internal jugular veins;
wherein the control unit is configured to process the first data and the second data to control the pressure actuators to apply the desired pressure profile on the body of the user according to the identified posture of the user, while maintaining the venous diameters within the predetermined desired ranges corresponding to the identified posture.

11. The system of claim 8, further comprising variably pressurized goggles configured to be worn by the at least one user and cover eyes of the at least one user; wherein the monitoring apparatus comprises an ocular proptosis detector, and the parameter comprises ocular proptosis;
wherein the control unit is configured is configured to process then first data and the second data, to control the pressure actuators to apply the desired pressure profile on the body of the user according to the identified posture of the user and to regulate air pressure within the goggles according to the identified posture in order to maintain the ocular proptosis within the predetermined desired range corresponding to the identified posture.

12. The system of claim 8, further comprising a respirator mask or helmet configured to be worn by the user to cover a mouth and nose of the user, the respirator mask being configured to provide variably pressurized air to the mouth and nose of the user;
the monitoring apparatus comprises a respiratory circuit pressure sensor and the parameter comprises respiratory circuit pressure;
wherein the control unit is configured is configured to process then first data and the second data, to control the pressure actuators to apply the desired pressure profile on the body of the user according to the identified posture of the user and to regulate the respirator mask or helmet according to the identified posture and to maintain the respiratory circuit pressure within the predetermined desired range corresponding to the identified posture.

13. The system of claim 8, wherein the monitoring apparatus comprises a central venous catheter, and the parameter comprises central venous pressure;
wherein the control unit is configured is configured to process the first data and the second data, to control the pressure actuators to apply the desired pressure profile on the body of the user according to the identified posture of the user and to regulate the pressure actuators according to the identified posture and to maintain the central venous pressure within the predetermined desired range corresponding to the identified posture.

14. The system of claim 1, wherein the posture recognition module comprises:
one or more cameras disposed in the spacecraft;
an image processing apparatus, configured to receive images from the cameras and identifying the at least one posture of the at least one user in the spacecraft and to generate, in real time or near-real time, the first data indicative of the identified postures of the at least one user.

15. The system of claim 1, wherein:
the communication unit is in communication with the spacecraft propulsion system and receives propulsion data indicative of the direction and force of generated by the propulsion system;
the control unit is configured to account for the propulsion data to select the desired pressure profile to be provide by the suit, so as to simulate gravity while accounting propulsion.

16. A pressure suit configured for being worn by a user, the pressure suit comprising:
a communication unit, configured to receive first data indicative of a posture of the user;
a plurality of pressure actuators located at different locations of the pressure suit and corresponding to respective body parts, each pressure actuator being configured to selectively apply variable pressure on the respective body part of the user when the pressure suit is worn by the user;
a control unit configured to process the first data in real time or near real time and to selectively operate the pressure actuators in real time or near real time, so as to apply a desired pressure profile on the body of the user according to the posture of the user indicated by the first data, in order to create a venous blood pool that is similar to a specific venous blood pool that the user would have on Earth for the a same posture.

17. The pressure suit of claim 16, wherein the control unit is configured to process the first data in real time or near real time and to selectively operate the pressure actuators in real time or near real time, so as to apply a desired pressure profile changes on the body of the user when the communication unit receives the first data that is indicative of a change between two postures, in order to create a venous blood pool change that is similar to a specific venous blood pool change that the user would experience on Earth for the same posture change.

18. A method for calibrating a pressure suit, for at least one user in a spacecraft in microgravity, a desired venous pool, the method comprising:
measuring, on Earth, one or more circulatory system parameter while switching a subject with a predetermined body habitus between different postures and recording measurements as calibration data;
in microgravity, providing the pressure suit so that the pressure suit is worn by the subject, the pressure suit comprising: a communication unit, configured to receive the first data relating to a posture of the user; a plurality of pressure actuators located at different locations of the pressure suit and corresponding to respective body parts, each pressure actuator being configured to selectively apply variable pressure on the respective body part of the user when the pressure suit is worn by the user; a control unit configured to process the first data in real time or near real time and to selectively operate the pressure actuators in real time or near real time, so as to apply a desired pressure profile on the body of the user according to the posture of the user indicted by the first data, in order to create a venous blood pool that is similar to a specific venous blood pool that the user would have on Earth a same identified posture;
activating the actuators of the pressure suit to generate pressure profiles, while one or more circulatory system parameters corresponding to the calibration data are measured;
adjusting the pressure profiles so that the circulatory system parameters measured in microgravity match to the circulatory system parameters of the calibration data;
once a match is found, determining a pressure profile for a respective posture is and programming the pressure suit to apply a pressure profile for the respective postures when the pressure suit receives the first data indicative of the respective postures, so as to provide, for each posture venous blood pooling that would occur for a same posture on Earth.

19. The method of claim 18 wherein:
the control unit is configured to process the first data in real time or near real time and to selectively operate the pressure actuators in real time or near real time, so as to apply desired pressure profile changes on the body of the user when the communication unit receives the first data that is indicative of a change between two postures, in order to create a venous blood pool change that is similar to a specific venous blood pool change that the user would experience on Earth for a same posture change.

20. (canceled)
